(19) United States
(12) Patent Application Publication
(10) Pub. No.: US 2024/0303028 A1
(43) Pub. Date: Sep. 12, 2024

(54) AUDIO DATA PROCESSING AND TRANSMISSION SYSTEM AND METHOD

(71) Applicant: MARS SEMICONDUCTOR CORP., HSINCHU CITY (TW)

(72) Inventors: LUEN-SHEN YUAN, HSINCHU CITY (TW); YI-SHING CHANG, HSINCHU CITY (TW)

(21) Appl. No.: 18/181,897

(22) Filed: Mar. 10, 2023

(51) Int. Cl. G06F 3/16

(52) U.S. Cl. CPC G06F 3/162

(57) ABSTRACT

An audio data processing and transmission system has multiple audio data transmitter devices and an audio data receiver device. The audio data receiver device is communicatively connected to the audio data transmitter devices. The audio data transmitter device acquires a piece of first audio data which has not been performed with digital signal processing and has no functions of the digital signal processing. The audio data receiver device receives multiple pieces of the first audio data transmitted by the audio data transmitter devices, and performs the digital signal processing on the multiple pieces of the first audio data which have not been performed with digital signal processing. The audio data transmitter devices have no digital signal processing circuits, and the work of the digital signal processing is transfer to the audio data receiver device, thus reducing an overall cost of the audio data processing and transmission system.

### TECHNICAL FIELD

The present disclosure relates to an audio data processing and transmission technology, and in particularly to, an audio data processing and transmission system and method, both of which can reduce a cost of a digital signal processing circuit and a chip area of the audio data transmitter device.

### RELATED ART

Refer to FIG. 1, and FIG. 1 is a schematic block diagram of a conventional audio data processing and transmission system. The conventional audio data processing and transmission system 1 comprises multiple audio data transmitter devices 10 and an audio data receiver device 11, wherein the audio data transmitter devices 10 are communicatively connected to the audio data receiver device 11, for example, via a wireless communication manner. Each of the audio data transmitter devices 10 comprises multiple audio input devices 101 (for example, microphones, but not limited thereto), a transmitter device 102, an antenna 103 and a digital signal processing circuit 104, wherein the digital signal processing circuit 104 is electrically connected to the transmitter device 102 and the audio input devices 101, and the transmitter device 102 is electrically connected to the antenna 103. The audio data receiver device 11 comprises multiple audio input devices 111 (for example, microphones, but not limited thereto), a receiver device 112, an antenna 113 and an audio output device 114 (for example, speaker, but not limited thereto), wherein the receiver device 112 is electrically connected to the antenna 113 and the audio output device 114.

Since each of the audio data transmitter devices 10 in the conventional audio data processing and transmission system 1 has the digital signal processing circuit 104, a cost and a chip area of the audio data transmitter device 10 are increased. Further, because the audio data transmitter device 10 usually receives electricity from a battery rather than a utility power, and the digital signal processing circuit 104 is included in the audio data transmitter device 10, the using time of the audio data transmitter device 10 is decreased. According, the conventional audio data processing and transmission system 1 should be improved to solve the above-mentioned problems.

### SUMMARY

According to an objective of the present disclosure, the present disclosure provides an audio data processing and transmission system. The audio data processing and transmission system comprises multiple audio data transmitter devices and an audio data receiver device. The audio data receiver device is communicatively connected to each of the audio data transmitter devices. The audio data transmitter device is configured to at least one piece of first audio data which has not been performed with digital signal, and in addition to a digital signal processing of parallel/serial conversion, the audio data transmitter device has no functions of the digital signal processing of other types. The audio data receiver device receives multiple pieces of first audio data transmitted by the audio data transmitter devices and performs the digital signal processing on the multiple pieces of first audio data. The digital signal processing, for example, comprises at least one of beamforming, audio mixing, echo cancelling, combining multiple channels to a single channel, separating the single channel to multiple channels, bit left shifting, bit right shifting, converting bit length of the audio data, digital amplification processing and digital filter processing, and the present disclosure is not limited thereto, but in one embodiment the digital signal processing does not comprise the parallel/serial conversion.

According to one embodiment of the present disclosure, each of the audio data transmitter devices comprises at least one first audio input device and a transmitter device. The first audio input device is configured to acquire a piece of first audio data which has not been performed with digital signal processing. The transmitter device is electrically connected to the at least one first audio input device and is configured to receive the piece of first audio data, and to transmit the piece of first audio data to the audio data receiver device.

According to one embodiment of the present disclosure, the audio data receiver device comprises a receiver device and at least one digital signal processing circuit. The receiver device is configured to receive multiple pieces of the first audio data transmitted by multiple transmitter devices of the audio data transmitter devices, all of which have not been performed with the digital signal processing. The digital signal processing is electrically connected to the receiver device, and configured to receive the multiple pieces of the first audio data transmitted by the receiver device, all of which have not been performed with the digital signal processing, and to perform the digital signal processing on the multiple pieces of the first audio data.

According to one embodiment of the present disclosure, each of the audio data transmitter devices does not comprise a digital signal processing circuit.

According to one embodiment of the present disclosure, the at least one digital signal processing circuit comprises multiple digital signal processing circuits, and the digital signal processing circuits form a digital signal processing module, such that the digital signal processing module performs the digital signal processing on the multiple pieces of the first audio data and the piece of the second audio data in parallel.

According to one embodiment of the present disclosure, the at least one first audio input device comprise multiple first audio input devices, and in addition to the digital signal processing of a parallel/serial conversion, each of the audio data transmitter devices does not perform the digital signal processing of other types on the multiple pieces of the first audio data, and the transmitter device of each of the audio data transmitter devices further comprises a parallel/serial conversion unit. The parallel/serial conversion unit is configured to perform the parallel/serial conversion on the multiple pieces of the first audio data which are input to the transmitter device (202) in parallel, such that the transmitter device (202) transmits the multiple pieces of the first audio data in serial.

According to at least one objective of the present disclosure, the present disclosure provides an audio data processing and transmission method which can be executed by one the above audio data processing and transmission systems.

In short, the audio data processing and transmission system and method provided by the present disclosure can make each of the audio data transmitter device do not perform the digital signal processing on the piece of the audio data, and the digital signal processing which is performed on the pieces of the audio data are transfer to the audio data receiver device. Therefore, it efficiently reduces a hardware cost and a circuit area of disposing the digital signal processing circuit in the audio data transmitter device. Further, it can increase the using time of the audio data transmitter device when the power of the audio data transmitter device is supplied by a battery.

### BRIEF DESCRIPTIONS OF DRAWINGS

The present disclosure can be more fully understood by reading the subsequent detailed description and examples with references made to the accompanying drawings, wherein dimensions and arrangement configurations in the drawings are for illustration only, and the present disclosure is not limited thereto. Each figure of the drawings is briefly illustrated as follows.

FIG. 1 is a schematic block diagram of a conventional audio data processing and transmission system.

FIG. 2 is a block diagram showing an audio data processing and transmission system according to an embodiment of the present disclosure.

FIG. 3 is a block diagram showing an audio data processing and transmission system according to another one embodiment of the present disclosure.

FIG. 4 is a flow chart of an audio data processing and transmission method according to an embodiment of the present disclosure.

### DETAILS OF EXEMPLARY EMBODIMENTS

The following description is of the best-contemplated mode of conducting the present disclosure. This description is made for the purpose of illustrating the general principles of the present disclosure and should not be taken in a limiting sense. The scope of the present disclosure is best determined by reference to the appended claims.

Because each of conventional audio data transmitter devices firstly performs digital signal processing on a piece of an audio data, and then transmits the piece of the audio data which has been performed with the digital signal processing to an audio data receiver device, each of the conventional audio data transmitter devices needs a digital signal processing circuit, and it increases the hardware cost and the circuit area in the audio data transmitter device. Further, because the audio data transmitter device usually receives electricity from a battery rather than a utility power, the power consumption of the conventional audio data transmitter device is fast, a battery life is not long, and the battery needs to be replaced or recharged frequently.

Due to the progress of current semiconductor process technology, more powerful, fast and low-cost digital signal processing circuit has appeared in the market, therefore, in order to solve the technical problems encountered in the prior art, in addition to parallel/serial conversion unit, there are no digital signal processing circuits of other types disposed in the audio data transmitter device of the present disclosure. In the present disclosure, the piece of the audio data acquired by the audio data transmitter device which has not been performed with the digital signal processing (except the parallel/serial conversion) is directly transmitted to the audio data receiver device, and the at least one digital signal processing circuit of the audio data receiver device performs the digital signal processing on the pieces of the received audio data, such that the audio data processing and transmission system which has the lower hardware cost and the longer battery lifetime in the audio data transmitter device can be achieved.

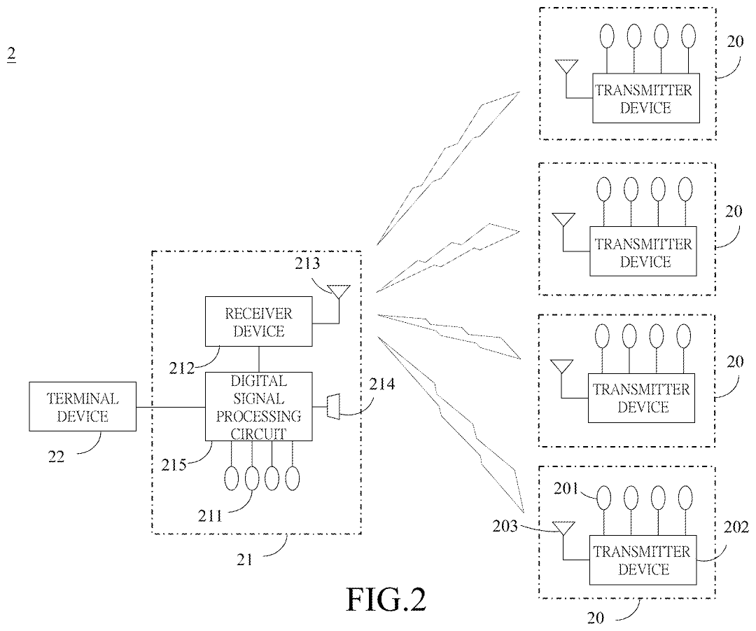

Refer to FIG. 2, and FIG. 2 is a block diagram showing an audio data processing and transmission system according to an embodiment of the present disclosure. The audio data processing and transmission system 2 comprises multiple audio data transmitter devices 20, an audio data receiver device 21 and a terminal device 22. The audio data receiver device 21 is communicatively connected to the audio data transmitter devices 20 and electrically connected to the terminal device 22. The audio data transmitter devices 20 are communicatively connected to the audio data receiver device 21 via a wireless communication manner, and the terminal device 22 and the audio data receiver device 21 are electrically connected to each other via a universal serial bus (USB), and transmission of the audio data between the terminal device 22 and the audio data receiver device 21 meets a USB audio (UAB) class specification. By the way, in one application, the audio data processing and transmission system 2 may not comprise the terminal device 22.

In the embodiment of the present disclosure, the audio data transmitter device 20 can be, for example, a wireless microphone device or a source audio data storage device, and the present disclosure is not limited thereto. The audio data receiver device 21 can be, for example, a wireless microphone/speaker device, a destination audio data storage device or a relay device for relay the audio data, and the present disclosure is not limited thereto. The terminal device 22 can be, for example, a personal computer, a notebook, a pad or a server device, and the present disclosure is not limited thereto.

The audio data transmitter device 20 is configured to acquire a piece of an audio data which has not been performed with the digital signal processing, and in addition to the parallel/serial conversion unit, the audio data transmitter device 20 does not has the digital signal processing circuit of other types. The audio data receiver device 21 receives the pieces of the audio data transmitted by the audio data transmitter devices 20 and performs the digital signal processing on the pieces of the audio data. The digital signal processing, for example, comprises at least one of beamforming, audio mixing, echo cancelling, combining multiple channels to a single channel, separating the single channel to multiple channels, bit left shifting, bit right shifting, converting bit length of the audio data, digital amplification processing and digital filter processing, and the present disclosure is not limited thereto. The broad definition of the digital signal processing comprises any processing that handles digital signals, but in one embodiment of the present disclosure, the digital signal processing excludes the serial/serial conversion. In addition, in another embodiment, it adopts the broad definition of the digital signal processing and serial/serial conversion processing is not excluded in the digital signal processing.

Specifically, the audio data transmitter device 20 comprises at least one audio input device 201 (usually, multiple audio input devices 201, for example, multiple microphones which form a microphone array), a transmitter device 202 and an antenna 203. The audio input device 201 is configured to acquire the piece of the audio data which has not been performed with the digital signal processing. The transmitter device 202 is electrically connected to the audio input device 201 and the antenna 203 and configured to receive the piece of the audio data, and to transmit the piece of the audio data to the audio data receiver device 21 via the antenna 203. The audio data transmitter device 20 does not comprise the digital signal processing circuit. In one embodiment of the present disclosure, the antenna 203 can be integrated in the transmitter device 202, for example, a chip antenna, and the present disclosure is not limited thereto.

By the way, the at least one audio input device 201 comprise multiple audio input devices 201 (for example, 4 microphones), and except the parallel/serial conversion, each of the audio data transmitter devices 20 does not performs the digital signal processing of other types on the piece of the audio data, and the transmitter device 202 of each of the data transmitter devices 20 further comprises a parallel/serial conversion unit (not shown in drawings). The parallel/serial conversion unit is used to perform the parallel/serial conversion on the piece of the audio data input by the in parallel, so that the transmitter device 202 transmits the piece of the audio data to in a serial. On the other hand, the audio input devices 201 and the transmitter device 202 can be electrically connected to each other by a serial peripheral interface (SPI), and the present disclosure is not limited thereto. For example, an inter-chip communication interface (I2C), an inter-chip audio interface (I2S) or other interfaces can also be used.

The audio data receiver device 21 comprises at least one audio input device 211 (usually, multiple audio input devices 211, for example, multiple microphones which form a microphone array), a receiver device 212, an antenna 213, an audio output device 214 and a digital signal processing circuit 215. The receiver device 212 is electrically connected to the antenna 213 and is configured to receive the multiple pieces of the audio data transmitted by the transmitter device 202 via the antenna 213. The digital signal processing circuit 215 is electrically connected to the receiver device 212, the audio input device 211, the audio output device 214 and the terminal device 22. The digital signal processing circuit 215 is configured to receive the multiple pieces of the audio data transmitted by the receiver device 212, and to perform the digital signal processing on the multiple pieces of the audio data. The terminal device 22 is configured to receive the multiple pieces of the audio data which have been performed with the digital signal processing, such that a user can operate the terminal device 22 to use the multiple pieces of the audio data which have been performed with the digital signal processing.

In addition, the audio input device 211 is configured to acquire a piece of another audio data which has not been performed with the digital signal processing, wherein the digital signal processing circuit 215 is further configured to perform the digital signal processing on the piece of the other audio data which is acquired by the audio input device 211 and has not been performed with the digital signal processing. The audio output device 214 outputs the pieces of the audio data which have been performed with the digital signal processing by the digital signal processing circuit 215. Each of the audio input devices 201, 211 is a microphone or an audio data storage device, and the audio output device 214 is a speaker, another audio data storage device or a relay device. Furthermore, in one of the application aspects, the audio data receiver device 21 may selectively not include at least one of the antenna 213, the audio input device 211 and the audio output device 214, and the present invention is not limited thereto.

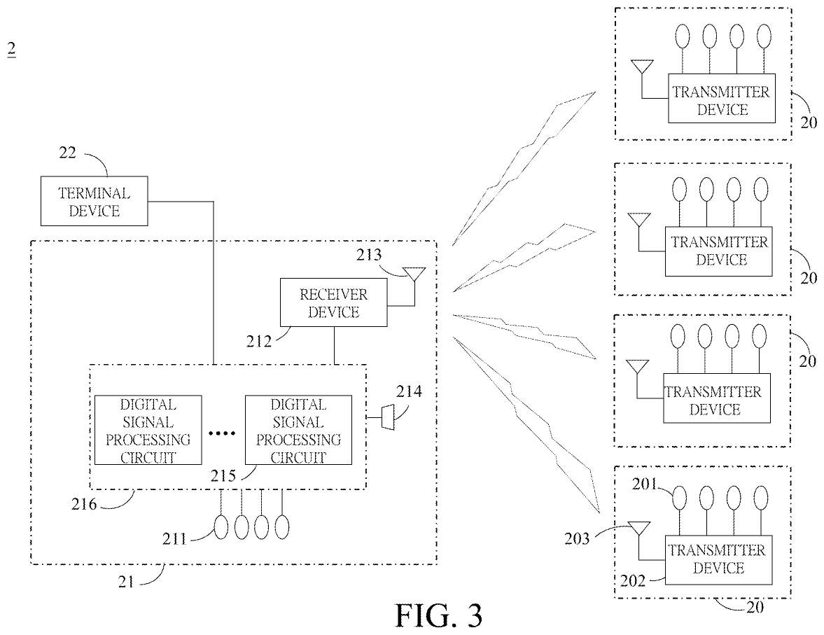

Next, refer to FIG. 3, and FIG. 3 is a block diagram showing an audio data processing and transmission system according to another one embodiment of the present disclosure. Different from the embodiment of FIG. 2, there are multiple digital signal processing circuits 215 in FIG. 3, and the multiple digital signal processing circuits 215 form a digital signal processing module 216, so as to perform the digital signal processing on the pieces of the audio data in parallel.

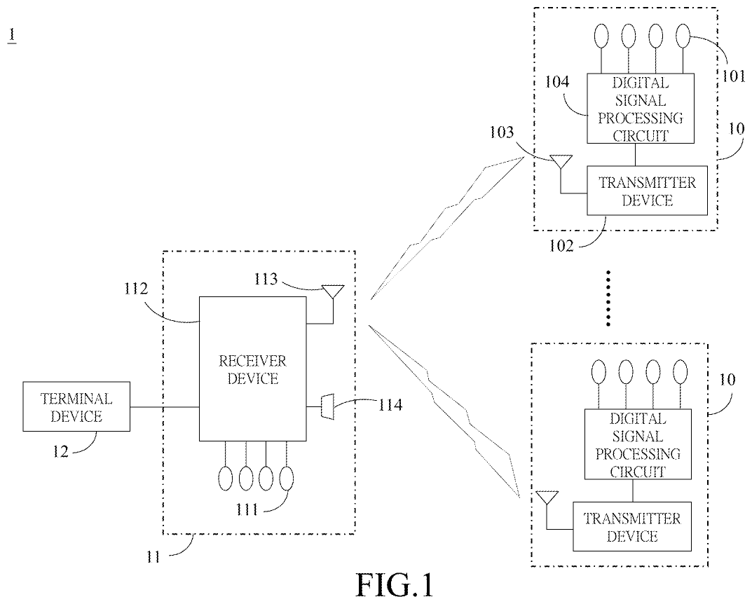

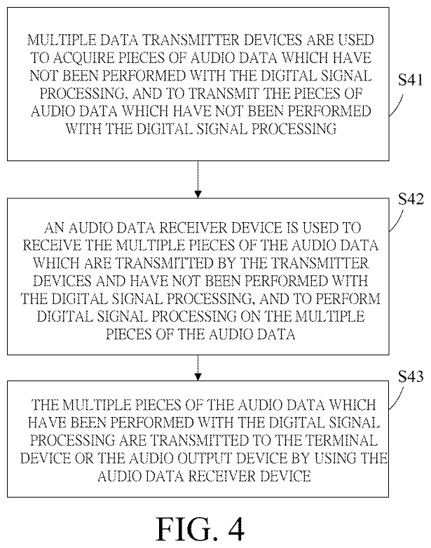

Next, refer to FIG. 4, and FIG. 4 is a flow chart of an audio data processing and transmission method according to an embodiment of the present disclosure. The audio data processing and transmission method comprises steps S41 and S42, and can selectively comprise a step S43. Firstly, at step S41, multiple data transmitter devices are used to acquire pieces of audio data which have not been performed with the digital signal processing, and to transmit the pieces of audio data which have not been performed with the digital signal processing. Next, at step S42, an audio data receiver device is used to receive the multiple pieces of the audio data which are transmitted by the transmitter devices and have not been performed with the digital signal processing, and to perform digital signal processing on the multiple pieces of the audio data. Next, at step S43, the multiple pieces of the audio data which have been performed with the digital signal processing are transmitted to the terminal device or the audio output device by using the audio data receiver device. In addition, the audio data processing and transmission method can selectively comprises the step of using the audio data receiver device to acquire a piece of another audio data which has not been performed with the digital signal processing and to perform the digital signal processing on the piece of other audio data which has not been performed with the digital signal processing. The details of the steps S41 to S43 can be seen the details of the audio data processing and transmission system in FIG. 1 or FIG. 2, and the redundant descriptions are thus omitted.

In short, the audio data processing and transmission system and method provided by the present disclosure can make each audio data transmitter device no longer need to carry out digital signal processing on audio data, and the digital signal processing of audio data is handed over to the audio data receiver device, so that it can effectively reduce the hardware cost and circuit area of the audio data transmitter device due to the need to set the digital signal processing circuit, and can increase the use time of the audio data transmitter device (if it is powered by a battery).

Accordingly, the present disclosure provides an audio data processing and transmission system and method, which utilize the audio data receiver device to perform the digital signal processing on the pieces of the audio data. All the used audio data transmitter devices do not need to the digital signal processing on the piece of the audio data, and the digital signal processing circuits will not be set in the audio data transmitter devices. Thus, it reduces a cost of a digital signal processing circuit and a chip area of the audio data transmitter device of the processing and transmission system. Simply put, the user can spend less money to build the audio data processing and transmission system, and unlike the prior art, the battery life of the audio data transmission device can be longer, reducing the frequency of battery replacement.

While the present disclosure has been described by way of example and in terms of preferred embodiment, it is to be understood that the present disclosure is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An audio data processing and transmission system, comprising:
multiple audio data transmitter device, each of the audio data transmitter devices comprises:
at least one first audio input device, configured to acquire a piece of first audio data which has not been performed with digital signal processing;
a transmitter device, electrically connected to the least one first audio input device, configured to receive the piece of the first audio data, and to transmit the piece of the first audio data; and
an audio data receiver device, communicatively connected to the audio data transmitter devices, comprising:
a receiver device, configured to receive multiple pieces of the first audio data transmitted by multiple transmitter devices of the audio data transmitter devices; and
at least one digital signal processing, electrically connected to the receiver device, configured to receive the multiple pieces of the first audio data transmitted by the receiver device, and to perform the digital signal processing on the multiple pieces of the first audio data transmitted by the receiver device.

2. The audio data processing and transmission system of claim 1, wherein each of the audio data transmitter devices does not comprise a digital signal processing circuit.

3. The audio data processing and transmission system of claim 2, wherein the audio data receiver device further comprises:
at least one second audio input device, electrically connected to the digital signal processing circuit, configured to acquire a piece of second audio data which has not been performed with the digital signal processing, wherein the digital signal processing circuit is further configured to perform the digital signal processing on the piece of the second audio data.

4. The audio data processing and transmission system of claim 3, wherein the audio data receiver device further comprises:
at least one audio output device, electrically connected to the digital signal processing circuit, configured to output the multiple pieces of the first audio data and the piece of the second audio data, all of which have been performed with the digital signal processing by the digital signal processing circuit.

5. The audio data processing and transmission system of claim 3, wherein the at least one digital signal processing circuit comprises multiple digital signal processing circuits, and the digital signal processing circuits form a digital signal processing module, such that the digital signal processing module performs the digital signal processing on the multiple pieces of the first audio data and the piece of the second audio data in parallel.

6. The audio data processing and transmission system of claim 3, wherein each of the at least one first audio input device and the least one second audio input device is a microphone or a first audio data storage device, and the audio output device is a speaker, a second audio data storage device or a relay device.

7. The audio data processing and transmission system of claim 3, further comprising:
a terminal device, electrically connected to the audio data receiver device, configured to receive the multiple pieces of the first audio data and the piece of the second audio data, all of which have been performed with the digital signal processing.

8. The audio data processing and transmission system of claim 7, wherein the audio data transmitter device and the audio data receiver device is communicatively connected to each other via a wireless communication manner, and the terminal device and the audio data receiver device are electrically connected to each other via a universal serial bus (USB), and transmission of the multiple pieces of the first audio data and the piece of the second audio data between the terminal device and the audio data receiver device meets a USB audio (UAB) class specification.

9. The audio data processing and transmission system of claim 1, wherein the at least one first audio input device comprise multiple first audio input devices, and in addition to the digital signal processing of a parallel/serial conversion, each of the audio data transmitter devices does not perform the digital signal processing of other types on the multiple pieces of the first audio data, and the transmitter device of each of the audio data transmitter devices further comprises:
a parallel/serial conversion unit, configured to perform the parallel/serial conversion on the multiple pieces of the first audio data which are input to the transmitter device in parallel, such that the transmitter device transmits the multiple pieces of the first audio data in serial.

10. An audio data processing and transmission method, comprising:
using at least one first audio input device of each of multiple audio data transmitter devices to acquire a piece of first audio data which has not been performed with digital signal processing;
using a transmitter device of each of the audio data transmitter devices to transmit the piece of the first audio data;
using a receiver device of an audio data receiver device to receive multiple pieces of the first audio data transmitted by multiple transmitter devices of the audio data transmitter devices; and
using at least one digital signal processing circuit of the audio data receiver device to perform the digital signal processing on the multiple pieces of the first audio data transmitted by the receiver device.
